(19) United States
(12) Patent Application Publication
(10) Pub. No.: US 2024/0152384 A1
(43) Pub. Date: May 9, 2024

(54) SYNCHRONOUS TRANSACTION ENHANCED CAPABILITY

(71) Applicant: International Business Machines Corporation, Armonk, NY (US)

(72) Inventors: Keith Donald Cramer, Pine Island, MN (US); Priya Ajay Ingle, Austin, TX (US); Jiawei WEN, Cedar Park, TX (US); Ramkumar Gowrishankar, Apex, NC (US)

(21) Appl. No.: 18/052,602

(22) Filed: Nov. 4, 2022

(51) Int. Cl. G06F 9/46

(52) U.S. Cl. CPC G06F 9/466

(57) ABSTRACT

According to an aspect, a computer-implemented method includes intercepting a call to invoke execution of a service as part of performing a synchronous transaction. A current state of the synchronous transaction is captured and persisted in a transaction object corresponding to the synchronous transaction. Execution of the service is invoked.

### BACKGROUND

The present invention generally relates to computer transactions, and more specifically, to computer systems, computer-implemented methods, and computer program products for providing synchronous transaction enhanced capability.

Synchronous transactions block until the transaction completes or fails. In contrast, an asynchronous transaction completes immediately and then reports back a status of complete or pending or failed, and the caller of the transaction may have to poll the system to determined when the transaction changes from a pending state to a completed or failed state.

Synchronous transactions typically include calling sub-transaction processing. For example, in a microservices architecture, a high-level transaction to create a resource can involve calling lower level transactions for multiple services and coordinating the results of these sub-transactions to complete the high level transaction.

### SUMMARY

Embodiments of the present invention are directed to a computer-implemented method for providing synchronous transaction enhanced capability. The method includes intercepting a call to invoke execution of a service as part of performing a synchronous transaction. A current state of the synchronous transaction is captured and persisted in a transaction object corresponding to the synchronous transaction. Execution of the service is invoked.

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of components of a synchronous transaction framework (STF) architecture in accordance with one or more embodiments of the present invention;

FIG. 3 depicts a block diagram of a STF sequence of operations in accordance with one or more embodiments of the present invention;

FIG. 4 depicts an example of transaction objects that are persisted for a successful transaction in accordance with one or more embodiments of the present invention;

FIG. 5 depicts an example of transaction objects that are persisted for a failed transaction in accordance with one or more embodiments of the present invention;

FIG. 6 depicts an example of persisted transaction objects that are used to replay a successful transaction in accordance with one or more embodiments of the present invention;

FIG. 7 depicts an example of query results that are returned by a system state query in accordance with one or more embodiments of the present invention;

FIG. 8 depicts an example of persisted transaction objects that are the result of an administrator client canceling an in-flight transaction in accordance with one or more embodiments of the present invention;

FIG. 9 depicts a flowchart of a method for providing synchronous transaction enhanced capability in accordance with one or more embodiments of the present invention; and

FIG. 10 is an example definition of a STF persisted transaction object.

### DETAILED DESCRIPTION

Embodiments of the present invention are directed to synchronous transaction enhanced capability. As described previously, synchronous transactions typically include calling sub-transaction processing. When the sub-transactions are being called, it is possible that a sub-transaction can fail, causing the high-level transaction to be reported as failed also. In this case, some of the sub-transaction processing may need to be rolled back, or undone. Typically, the high-level transaction keeps track of the coordination in memory, and contemporary approaches write specific rollback logic for each possible sub-transaction failure. One problem with this approach is how to handle a server outage, or crash, with in-flight synchronous transactions. When this happens, the intermediate state of the interrupted transaction is typically lost when the server memory is cleared on the crash, and the system may need to include garbage collection processes to clean up failed partial transactions.

Another issue with contemporary implementations of synchronous transactions is that when a system outage occurs there is no good way for the system to determine the transactions that were in-flight at the time of the outage in order to automatically resume the transaction when the system outage is restored.

Another issue with contemporary implementations of synchronous transactions is that a user does not have visibility into the status of the synchronous transaction (e.g., which sub-step the transaction is currently on). Since the transaction call is blocked until it is complete and the intermediate processing state is in memory of the transaction handler, there is no good way to report the in-progress status to the user.

A further issue with contemporary synchronous transactions is that if a user wants to cancel the transaction in-flight there is typically not a good way to accomplish this since the original request blocks until the transaction is complete.

A further issue with contemporary synchronous transactions is that if a user wants to see the history of issued transactions and the results of the transactions, they typically have to persist the transaction request/results details directly via a logging mechanism or a transaction history file. Even with this approach, there is not a good way for the user to know the details of a failed transaction due to system outages, as the transaction handler communications cuts off and that is all that the transaction history maintained by the user can report (i.e., that the transaction handler has cut off communication). To get the full picture of the failure, the server transaction logs need to be inspected, and the user may not have access to these server side logs (e.g., for security reasons).

One or more embodiments of the present address one or more of the above noted deficiencies of contemporary synchronous transaction implementations by providing an efficient mechanism that is used to track synchronous transactions, including intermediate transaction processing, in a system. This tracking ability is provided without requiring changes to existing code of the clients or the services. Thus, the mechanism can be used generically by any synchronous transaction handler.

One or more embodiments of the mechanism provide rollback for failed sub-transaction steps when a transaction fails. In addition, one or more embodiments of the mechanism provide the ability to resume failed transactions caused by system server outages and the ability to report the completion to the user. In addition, one or more embodiments of the mechanism provide the ability to report intermediate states of in-flight synchronous transactions to the user. Further, one or more embodiments of the mechanism allow a user to cancel an in-flight synchronous transaction. Further, one or more embodiments of the mechanism allow a user to view the server-side state of transactions including in-flight, completed, and failed transactions (including details about the failure).

An overview of features of one or more embodiments of the present invention follow:

Synchronous transaction framework (STF). One or more embodiments include a STF, or STF proxy, that allows synchronous transactions to be persisted with a state. This capability can be utilized, for example, in a microservices architected system. Synchronous transactions can be long lived and have many levels (sub-transactions). The client request must block until all of the processing is complete. The STF allows synchronous transactions to be “captured” by the framework. The framework creates a “transaction object” that represents the transaction and the object is persisted (saved) in the system. For example, the system can persist the transaction object in a file system, or as a database entry, or as a Kubernetes object.

Transaction state capture. When the transaction object is created, it is populated with the initial top level transaction details, and as subsequent steps are processed additional sub-transaction objects are created and persisted. As the processing of the steps are completed, the STF proxy updates the corresponding transaction objects with the service call results. Each transaction/sub-transaction object has identifying attributes that can be used to recreate a successful transaction, or to rollback a failed transaction by iterating over the persisted transaction objects.

Playback of a transaction. Since all of the transaction and sub-transaction steps, call address, call sequence, input parameters and results are persisted in the transaction objects, it is possible to use these objects to populate a new instance of the system by iterating over the transaction objects and executing these calls again.

Rollback of a transaction. If a transaction fails, the system can iterate over the persisted transaction objects and rollback the partial system state by calling the failing services with a rollback request in the proper call sequence. For example, by deleting the dependent resource(s) that was created for the failed transaction and updating the transaction state object to show the rollback status of each step. If the rollback processing fails, this is also recorded in a new transaction object. Later, a garbage collection process can query all the transaction objects and find failed rollback steps, and report this to the system users and/or attempt to redo failed rollback steps.

System outage. If there is a system outage, due for example to a server crash, or network communications interruption, the transaction objects will have persisted the current intermediate state of all in-flight transactions. When the outage is over, the server can query for and process all of the in-flight incomplete transactions and either resume the transactions, or rollback the transactions based on the user input (failure processing state) of the original transaction.

System state query. Users can query the STF to get a list of all transactions including completed, failed and in-flight transactions. For in-flight transactions, a user can review the step it is on in the processing flow which can allow a client to report an in-progress status of the synchronous transaction. For example, if a transaction includes ten sub-transactions, the framework can return a full list of the transaction objects, and the client can then see that only four of the ten sub-transaction objects have been completed and the fifth one is in progress. This allows the client to report more detailed progress that is not typically available in traditional system implementations.

Transaction cancel capability. If a client has a running synchronous transaction that has not completed, one more embodiments of the present invention allow the client to issue a “cancel” request using the transaction identifier from the persisted transaction object. As the synchronous transaction is being processed, it is continually interacting with the STF proxy service. When the STF proxy sees the cancel request with the target transaction, it sets the latest sub-transaction to a cancel return code. This will cause the services to stop calling additional sub-transactions and return the cancel result to the client. The client can then issue a rollback transaction on the canceled transaction.

System transaction migration. One other aspect of one or more embodiments of the present invention is the ability to use the persisted transaction objects to back up a system or to migrate the system. In effect, the transaction objects are a history of top-level transactions in the system including all sub-transactions. If these objects are “replayed”, then transactions can be applied again or used in cloning the system by playing the transactions on a new system install.

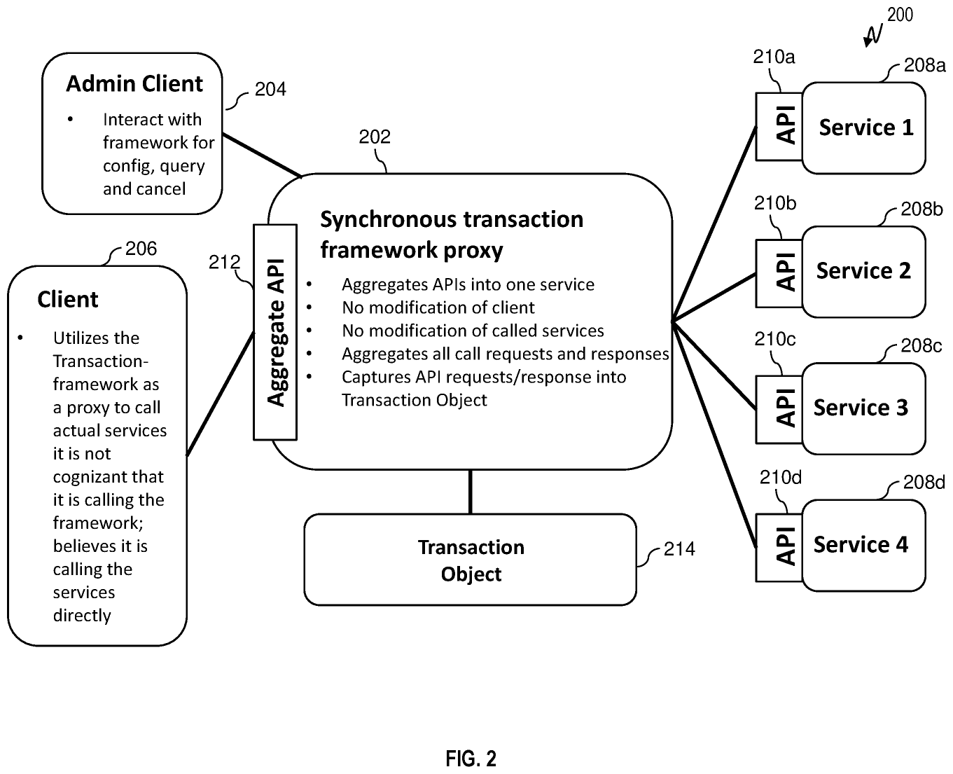

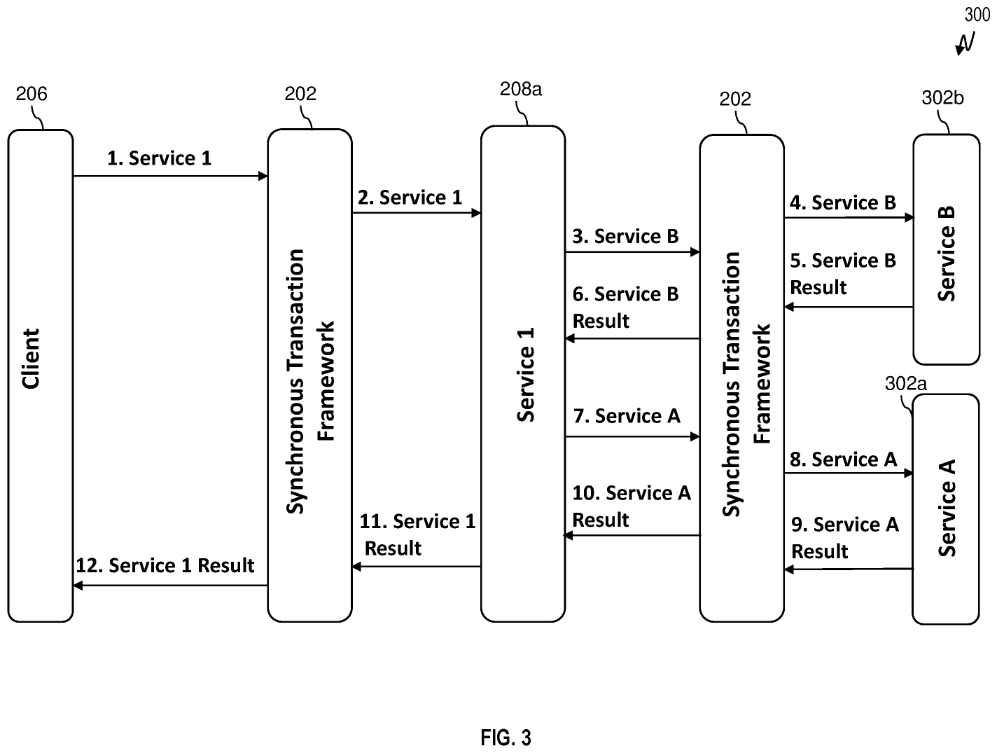

Transaction capture implementation—system library. The implementation of the STF proxy can be done in multiple ways. In one or more embodiments, a library package can be created in multiple coding languages and a user that wants to implement the capability can instrument the transaction capture by coding a library call to capture the request and reply for each service call. This approach requires source code changes on the server side of each supported transaction and sub-transactions. In addition, the client is agnostic of the implementation details. In accordance with one or more embodiments of the present invention, the STF caches the required transaction data before calling the API that implements the functionality. In one or more other embodiments, where there is no code change to the server or when the client is implementing STF as a proxy service that sits between the client and server as described below in reference to FIG. 2, the requests from the client are routed to the STF proxy endpoint. In a microservice environment, this can either be done by changing the domain name system (DNS) resolver to return the internet protocol (IP) address of the STF proxy (202 in FIG. 3) instead of the services (e.g., 208 or 302 in FIG. 3) or by changing the deployment files for the client to change the server uniform resource locator (URL).

One or more embodiments of the present invention can be used by any system with synchronous transactions to solve many of the critical issues such as those mentioned above that are inherent in the way these handlers are typically implemented.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the synchronous transaction enhanced capability block 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

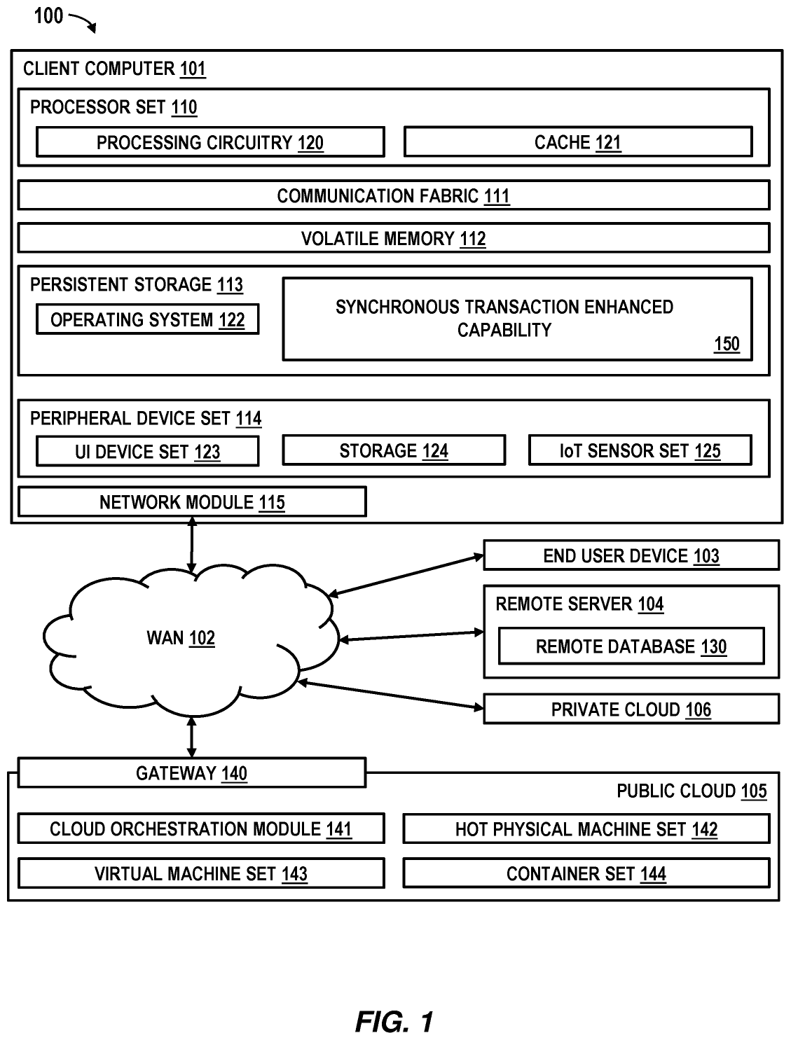

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In exemplary embodiments, methods, systems, and computer program products for virtual machine failover using disaggregated shared memory are provided. In one embodiment, a virtual machine disposed on a first computing system is configured to store the main program memory in a shared memory device that is separate from the first computing system. When a failure of the first computing device is detected, the virtual machine is restored on a second computing system using the main program memory from the shared memory device.

Turning now to FIG. 2, a block diagram 200 of components of a STF architecture is generally shown in accordance with one or more embodiments of the present invention. In accordance with one or more embodiments of the present invention, the components shown in FIG. 2 are implemented by one or more elements of the computing environment 100 shown in FIG. 1. All or a subset of the components shown in FIG. 2 can be implemented by portions of the client computer 101, end user device 103, remote server 104, private cloud 106, and/or public cloud 105 shown in FIG. 1.

The components shown in FIG. 2 include STF proxy 202; administrator client 204; client 206; Service 1 208a, Service 2 208b, Service 3 208c, and Service 4 208d, referred to collectively herein as services 208; Service 1 API 210a, Service 2 API 210b, Service 3 API 210c, and Service 4 API 210d, referred to collectively herein as service APIs 210; aggregate API 212, and transaction object 214.

The client 206 shown in FIG. 2 can be an instantiation of software code executing on a processor, where the executing includes calling one or more of the services 208 via a service API 210. Only one client 206 is shown in FIG. 2, however it should be understood that this is for ease of description and that multiple clients 206 can be connected to the aggregate API 212.

In accordance with one or more embodiments of the present invention, a service 208 (which may be a microservice) is an instantiation of software that may call other services to perform a particular function. Four services 208 are shown in FIG. 2 and it should be understood that more or fewer than four service APIs 210 can be connected to the STF proxy 202. Though just one transaction object 214 is shown in FIG. 2, typically there are multiple transaction objects 214 including one transaction object 214 for each transaction and sub-transaction as described further below.

In the embodiment shown in FIG. 2, the STF is implemented as a proxy service, STF proxy 202, located between the original client 206 and the service APIs 210. In accordance with one or more embodiments of the present invention, the STF proxy 202 is enabled between different microservices and not just the client 202 so that a complete capture of transaction and sub-transactions can be performed.

This implementation mechanism, the STF proxy 202, shown in FIG. 2 requires no modification to the client 206 or to the server side services 208 that make up the system. The system administrator deploys the STF as proxy services in front of the actual microservices, or services 208. The client code is unchanged. The connection of the client to the STF proxy 202 (e.g., to point to the aggregate API 212) instead of to the service APIs 210 can be done, for example, using one of the following mechanisms: (1) change the deployment file of client 206 to point to the STF proxy 202 instead of individual services, or (2) change the networking implementation so that the DNS query from the client 206 for service URL returns the IP address of the STF proxy 202 instead of the IP address of the service(s) 208. The aggregate API 212 provides all the APIs that the clients 206 would need from the services 208 that are provided via the service APIs 210. It offers all the capabilities of a service API 210 but instead of providing the actual implementation, it passes the data to STF proxy 202 which in turn calls the service API 210.

In accordance with one or more embodiments of the present invention, the STF proxy 202 executes its capture logic and forwards the request to the target microservice URL (e.g., which has the address of a service API 210 of the target service 208). Both the client 206, and all of the server side services 208, or microservices, are not cognizant that a call is made to the STF proxy 202, and they operate as if the client 206 is calling the service 208 directly. In accordance with one or more embodiments of the present invention, the back-end of the STF proxy 202 persists transaction object data to a database as a transaction object 214 corresponding to the transaction.

The embodiment of the STF architecture shown in FIG. 2 provides the following features: API aggregation (aggregates all APIs into one service without requiring any modification to client or service API code); requests and responses aggregation (aggregates all call requests and responses so, that it can handle any request either from the client 206 or any service API 210, and it can send the response back); transaction object persistent storage (captures API requests/responses into transaction objects 214, with each transaction object 214 having all necessary fields to represent the requests/responses as well as a sub-transaction attribute to capture all aggregated sub-transactions, where the transaction objects 214 are stored in a database for playback/rollback/recovery.

The client 206 shown in FIG. 2 calls the services 208 through the STF proxy 202. The administrator client 204 shown in FIG. 2 can be used to query the STF proxy 202 to obtain transaction states and to cancel in-flight transactions.

Turning now to FIG. 3, a block diagram 300 of a STF sequence of operations is generally shown in accordance with one or more embodiments of the present invention.

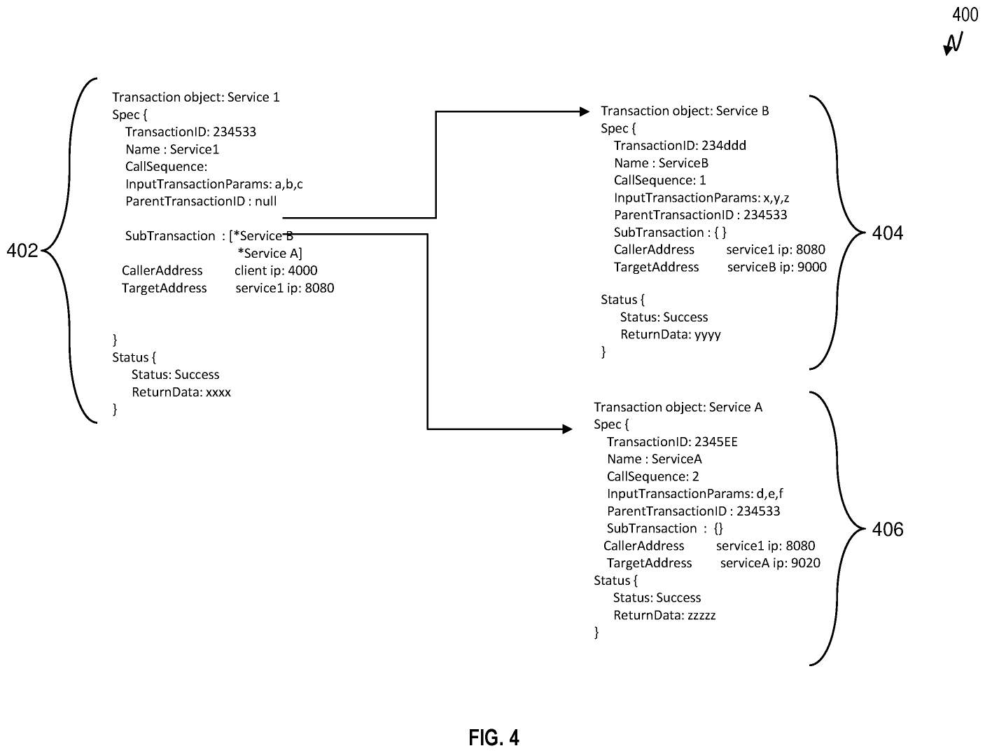

The block diagram shows the sequence of starting with the client 206 for the Service 1 208a synchronous transaction including where the STF proxy 202 intercepts the calls, processing logic performed by the framework, and an example of data captured in the transaction objects. The block diagram 300 of FIG. 3 is used to describe the processing performed in different scenarios of one or more embodiments of the present invention as described below with reference to FIGS. 4-8.

The block diagram 300 of FIG. 3 shows the client 206 which in the examples below is located at IP address 4000, the Service 1 208a which is located at IP address 8080, Service B 302b which is located at IP address 9000, and Service A 302a which is located at IP address 9020. In the example shown in FIG. 3, the client 206 calls Service 1 208a, Service 1 208a calls Service B 302b and then calls Service A 302a. The results are then sent back to the client 206. As shown in FIG. 3, each of the calls and responses (results) between the services are intercepted by the STF proxy 202.

In reference to the sequence numbers shown in FIG. 3, the embodiment of the processing shown in FIG. 3 includes:
1. Client 206 calls Service 1 208a.
2. STF proxy 202 intercepts the call to Service 1 208a and forwards the call to Service 1 208 (after saving a state of the call, or transaction, to a Service 1 transaction object).
3. Service 1 208a calls Service B 302b.
4. STF proxy 202 intercepts the call to Service B 302b and forwards the call to Service B 302b (after saving a state of the call, or transaction, to a Service B transaction object).
5. Service B 302b returns a result which is intercepted by STF proxy 202.
6. STF proxy 202 forward the result from Service B 302b to Service 1 208a (after updating a state of the Service B and Service 1 transaction objects).
7. Service 1 208a calls Service A 302a.
8. STF proxy 202 intercepts the call to Service A 302a and forwards the call to Service A 302a (after saving a state of the call, or transaction, to a Service A transaction object).
9. Service B 302a returns a result which is intercepted by STF proxy 202.
10. STF proxy 202 forward the result from Service A 302a to Service 1 208a (after updating a state of the Service A and Service 1 transaction objects).
11. Service 1 208a returns a result which is intercepted by STF proxy 202.
12. STF proxy 202 forward the result from Service 1 208a to the client 206.

Turning now to FIG. 4, an example of transaction objects 400 that are persisted for a successful transaction are generally shown in accordance with one or more embodiments of the present invention. The transaction objects 400 shown in FIG. 4 include Service 1 transaction object 402, Service B transaction object 404, and Service A transaction object 406. In reference to the example and sequence numbers shown in FIG. 3, the processing a successful transaction in accordance with one more embodiment of the present invention includes the following steps:
1. Client 206 calls Service 1 208a via STF proxy 202 and the STF proxy 202 creates service 1 transaction object 402. When the service 1 transaction object 402 is created, it includes Transaction ID=234533 which is used to tie all of the transaction objects 400 together; Name=Service 1; Call Sequence=blank since this is the top level call from the client 206; Input Parameters=a, b, c; and Parent Transaction ID=null since Service 1 is 208a is called by the client 206; Caller Address=4000 which is the IP address of the client 206; Target Address=8080 which is the IP address of Service 1 208a; and Status=In Progress.
2. STF proxy 202 calls Service 1 208a.
3. Service 1 208a calls Service B 302b via STF proxy 202 and the STF proxy 202 creates service B transaction object 404 and updates the Sub Transaction field of service 1 transaction object 402 with a pointer to the newly created service B transaction object 404. When the service B transaction object 404 is created, it includes Transaction ID=234ddd; Name=Service B; Call Sequence=1 since this is the first service called by Service 1 208a; Input Parameters=x,y,z; and Parent Transaction ID=23453; Caller Address=8080 which is the address of Service 1 208a; Target Address=9000 which is the IP address of Service B 302b and Status=In Progress.
4. STF proxy 202 calls Service B 302b.
5. Service B 302b returns result to STF proxy 202 and STF proxy 202 updates service B transaction object 404 with the results in the Status field including a Status=Success and Return Data=yyyy.
6. STF proxy 202 returns Service B 302b results to Service 1 208a.
7. Service 1 208a calls Service A 302a via STF proxy 202 and STF proxy 202 creates service A transaction object 406 and updates the Sub Transaction field of service 1 transaction object 404 with a pointer to the newly created service A transaction object 406. When the service A transaction object 406 is created, it includes Transaction ID=2345EE; Name=Service A; Call Sequence=2 since this is the second service called by Service 1 208a; Input Parameters=d, e, f; and Parent Transaction ID=23453; Caller Address=8080 which is the address of Service 1 208a; Target Address=9020 which is the IP address of Service A 302a and Status=In Progress.
8. STF proxy 202 calls Service A 302a.
9. Service B 302b returns result to STF proxy 202 and STF proxy 202 updates service A transaction object 406 with results in the Status field including a Status=Success and Return Data=zzzzz.
10. STF proxy 202 returns Service A results to Service 1 208a.
11. Service 1 208a returns result to STF proxy 202 and STF proxy 202 updates service 1 transaction object 402 with results including a Status=Success and Return Data=xxxx.
12. STF proxy 202 returns results to client 206.

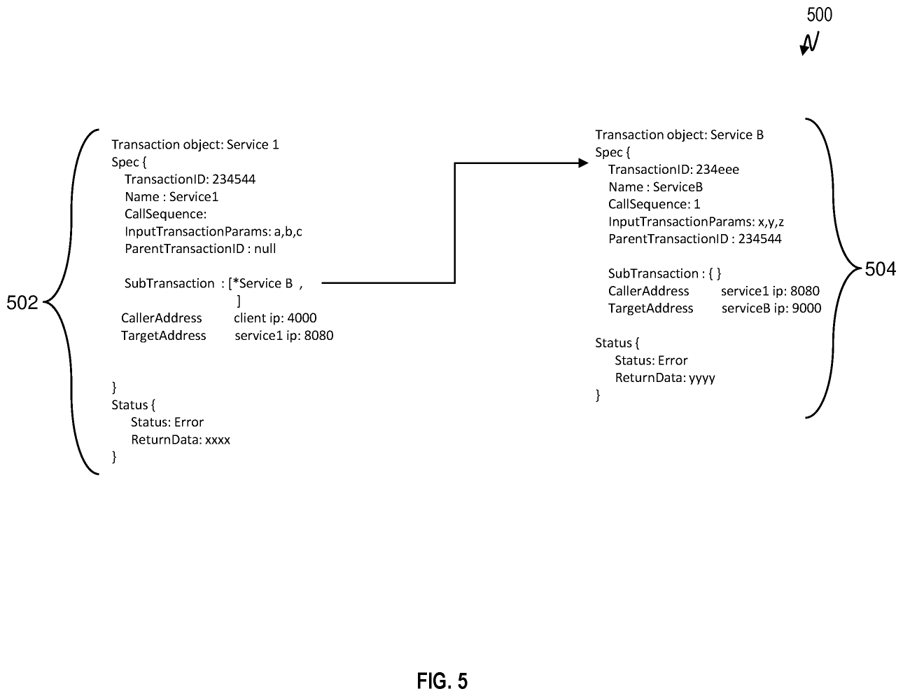

Turning now to FIG. 5, an example of transaction objects 500 that are persisted for a failed transaction are generally shown in accordance with one or more embodiments of the present invention. For an error transaction all of the request/data for the microservice calls that were completed will be persisted. In the example shown in FIG. 5, this includes the transaction objects for Service 1 (service 1 transaction object 502) and Service B (service B transaction object 504) which is the failing service. When the error result is returned to Service 1 208a, Service 1 208a will not call service A 302a since there is a failure of the transaction already (i.e., Service B 302b). When Service 1 208a returns an error to the client 206, the STF proxy 202 will also capture this in the Service 1 transaction object 502.

In reference to the example and sequence numbers shown in FIG. 3, the processing a failed transaction in accordance with one more embodiment of the present invention includes the following steps:
1. Client calls Service 1 208a via STF proxy 202 and the STF proxy 202 creates a service 1 transaction object 502 as described above with respect to service 1 transaction object 402 of FIG. 4.
2. STF proxy 202 calls Service 1 208a.
3. Service 1 208a calls Service B 302b via STF proxy 202 and the STF proxy 202 creates service B transaction object 504 as described above with respect to service B transaction object 404 of FIG. 4 and the STF proxy 202 updates the Sub Transaction field of service 1 transaction object 502 with a pointer to the newly created service B transaction object 504.
4. STF proxy 202 calls Service B 302b.
5. Service B 302B returns result (error) to STF proxy 202 and STF proxy 202 updates service B transaction object 504 with the results in the Status field including a Status=Error and Return Data=yyyy.
6. STF proxy 202 returns Service B 302b results to Service 1 208a including the error return code.
11. Service 1 208a returns result to STF proxy 202 and STF proxy 202 updates service 1 transaction object 502 with results including a Status=Error and Return Data=xxxx.
12. STF proxy 202 returns results to client 206.

One or more embodiments of the present invention can be utilized to rollback a failed transaction. If a synchronous transaction fails, the persisted transaction objects can be used to rollback the failed transaction and sub-transactions. For example, a request to rollback transaction ID 234544 in FIG. 5 allows the STF proxy 202 to act as a client and request the failed step (Service B 302b) transaction ID 234eee to be rolled back. Since the framework has each transaction and sub-transaction step, it can rollback the partially completed synchronized transaction without requiring the system implementors to privately persist incomplete transaction states in the system implementation.

One or more embodiments of the present invention can be utilized to recover failed transactions that failed due, for example to transient issues such as a system outage. When the system is recovered, one or more embodiments of the framework described herein can recover failed transactions based on the transaction objects stored in persistent storage. For example, if Service B 302b returns a return code of timeout because of an outage, and Service 1 208a also has a timeout return code, this indicates that the synchronous transaction failed because of an environmental outage. Since the transaction object for Service 1 208a is persisted, a system administrator can request that Service 1 208a be cleaned up as a rollbacked failed transaction and then “replayed” to allow automated system recovery of the failed transaction.

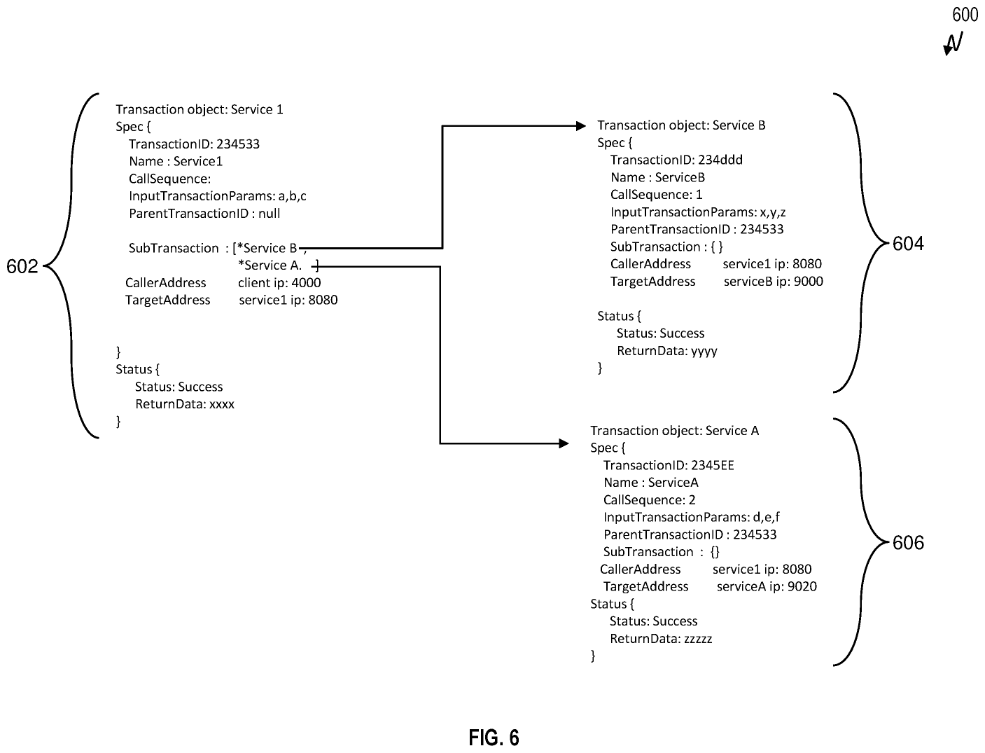

Turning now to FIG. 6, an example of persisted transaction objects 600 that are used to replay a successful transaction are shown in accordance with one or more embodiments of the present invention. The transaction objects 600 shown in FIG. 6 include Service 1 transaction object 602, Service B transaction object 604, and Service A transaction object 606. Based on the contents of a successful transaction object, such as Service 1 transaction object 402 of FIG. 4, one or more embodiments of the STF proxy 202 can replay the entire transaction to clone the transactions to a new domain. For example, the processing described above in reference to FIG. 4 could have been performed in Domain X and there is a request to replay the transaction (transaction ID: 234533) in Domain Y. This can be performed by allowing the STF proxy 202 to act as the client and reissue the transaction. If the replayed transaction fails, the STF proxy 202 will capture new transaction objects to persist what happened. This capability allows an administrator to clone transactions to a new instance of the system.

In this example, the client 206 calls Service 1 208a in Domain Y via the STF proxy 202 and passes it the transaction ID 234533. The STF proxy 202 creates service 1 transaction object 602 in Domain Y by looking at its internal cache of transaction objects. The processing continues with the steps shown in reference to FIG. 4. If the replayed transaction is successful, it will have the same transaction objects 600 as those shown in FIG. 4. If successful, Service 1 transaction object 602 is the same as Service 1 transaction object 402, Service B transaction object 604 is the same as Service B transaction object 404, and Service A transaction object 606 is the same as Service A transaction object 606.

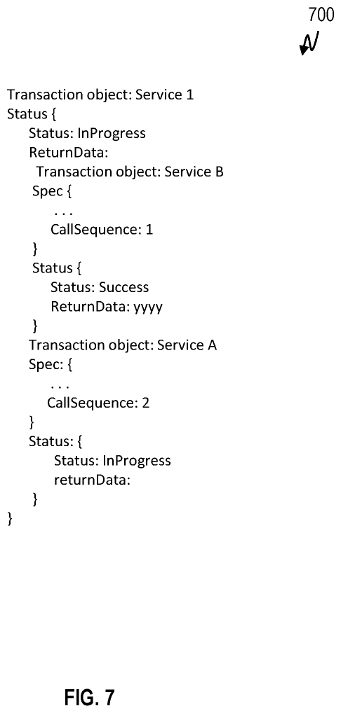

Turning now to FIG. 7, an example of query results 700 that can be returned by a system state query is generally shown in accordance with one or more embodiments of the present invention. Users can query the STF proxy 202 (e.g., via the administrator client 204 of FIG. 2) to get a list of all transactions including completed, failed and in-flight transactions. For an in-flight transaction a user can review the step it is on in the processing flow which can allow a client to report an in-progress status on the synchronous transaction. For example, as shown in FIG. 7, if a transaction includes two sub-transactions, the STF proxy 202 can return query results 700 that include a full list of the transaction objects associated with the transaction and the client can then see that only one of the two sub-transaction objects have been completed (in this example Service B 302b) and that the second sub-transaction (in this example service A 302a) is in progress. This allows the client to report more detailed progress that is not typically available in traditional synchronous transaction system implementations.

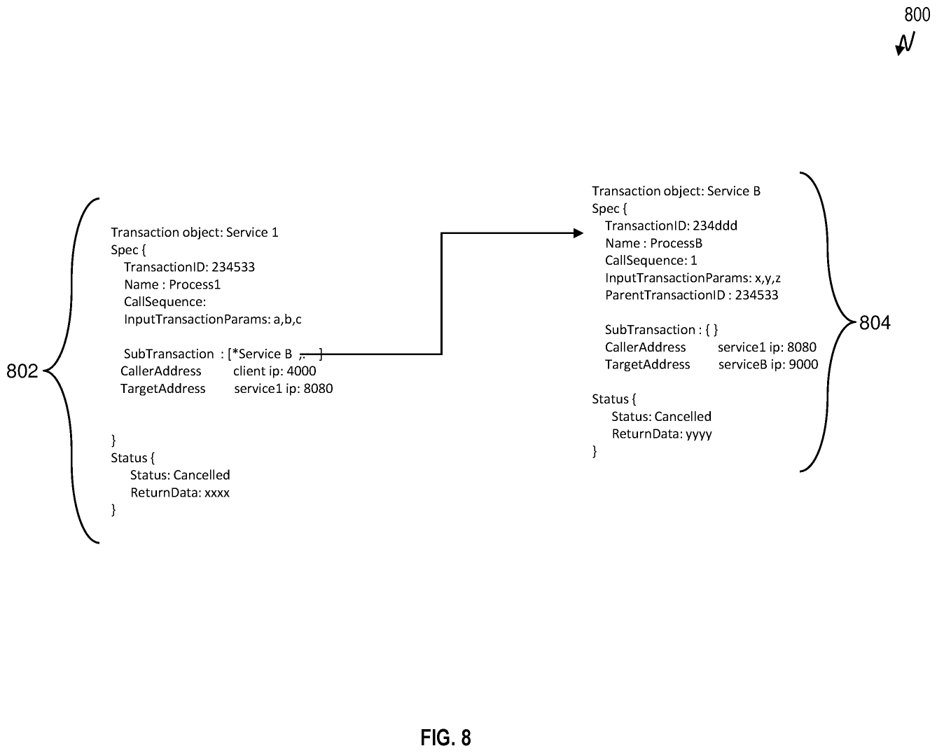

Turning now to FIG. 8, an example of persisted transaction objects 800 that are the result of an administrator client (e.g., client 206 or administrator client 204 of FIG. 2) canceling an in-flight transaction are generally shown in accordance with one or more embodiments of the present invention. If a client has a running, or in-flight, synchronous transaction that has not completed, one or more embodiments of the present invention allow the client to issue a “cancel” request using the transaction ID from the persisted transaction object corresponding to the transaction to be canceled. As the synchronous transaction is being processed, it is continually interacting with the STF proxy 202 service. When the STF proxy 202 sees the “cancel” request with the target transaction it sets the latest sub-transaction of the transaction to a cancel return code. This causes the services to stop calling additional sub-transactions and returns the cancel result to the client. The client can then issue a rollback transaction on the canceled transaction.

The transaction objects 800 shown in FIG. 8 include Service 1 transaction object 802 and Service B transaction object 804. In reference to the example and sequence numbers shown in FIG. 3, the process of canceling a transaction in accordance with one more embodiment of the present invention includes the following steps:
1. Client 206 calls Service 1 208a via STF proxy 202 and the STF proxy 202 creates Service 1 transaction object 802.
2. STF proxy 202 calls Service 1 208a.
3. Service 1 208a calls Service B 302b via STF proxy 202 and the STF proxy 202 creates Service B transaction object 804.
4. STF proxy 202 calls Service B 302b.
Administrator client 204 calls STF proxy 202 to cancel the transaction.
STF proxy 202 sees that Service 1 208a is in progress and that a call to Service B 302b is in progress.
5. Service B 302b returns result to STF proxy 202 and STF proxy 202 updates Service B transaction object 804 with result.
STF proxy 202 updates return code in the service B transaction object 804 with error/cancel return code.
Service 1 208a sees a cancel return code for call to Service B 302b and terminates processing and returns an error to the client 206.
STF proxy 202 sees the cancel return code and updates the Service 1 transaction object 802 with a status of cancel.

The processing of canceled in-flight transactions as described above can allow faster clean-up of transactions when compared to contemporary systems that do not support a cancel capability recursively and that require the synchronous transaction to complete.

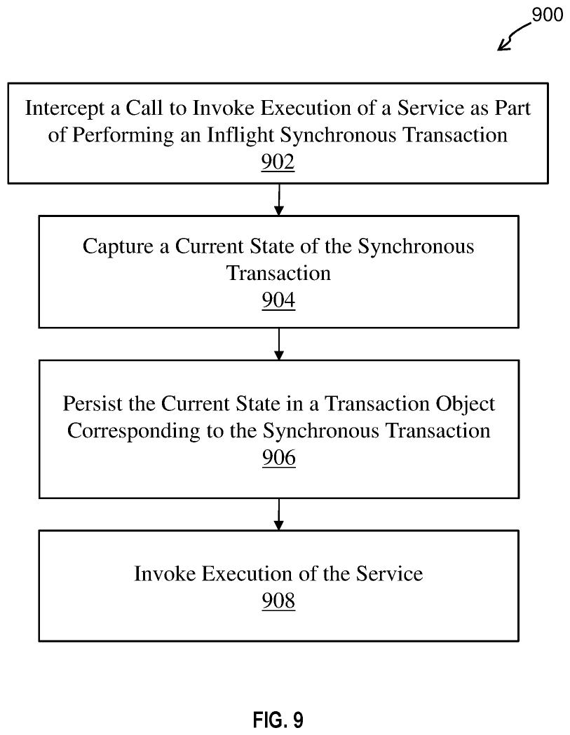

Turning now to FIG. 9, a flowchart of a method 900 for providing synchronous transaction enhanced capability is generally shown in accordance with one or more embodiments of the present invention. In one or more embodiments, the processing shown in FIG. 9 is performed by an STF, such as STF proxy 202 of FIG. 2, executing in the computing environment 100 of FIG. 1. The flowchart shown in FIG. 9 may include additional steps not depicted in FIG. 9. Although depicted in a particular order, the blocks depicted in FIG. 9 can be rearranged, subdivided, and/or combined.

At block 902, a call to invoke execution of a service as part of performing a synchronous transaction is intercepted, for example by STF proxy 202 of FIG. 2. The call can be from a client or from another service. Referring to the examples above, the call may be received, for example from client 206 or administrator client 204 of FIG. 2, or received from a service such as services 208, Service B 302b, or Service A 302a. As described previously, the intercepting is performed in a manner that it transparent to the client and to the service.

At block 904, a current state of the synchronous transaction is captured, for example by STF proxy 202 of FIG. 2. At block 906, the current state of the transaction is persisted, for example by STF proxy 202 of FIG. 2, in a transaction object that corresponds to the synchronous transaction. Examples of a transaction objects and current state data that can be persisted are shown above in FIGS. 4-6.

At block 908, execution of the service is invoked by, for example the STF proxy 202 of FIG. 2, by sending the transaction to the API of the service. In accordance with one or more embodiments of the present invention, a result of the call returned by the service having an intended recipient is intercepted and a new state of the synchronous transaction is captured and persisted based at least in part on the result. Referring to the examples above, the intended recipient may be, for example from client 206 or administrator client 204 of FIG. 2, or a service such as services 208, Service B 302b, or Service A 302a. As described previously, in accordance with one or more embodiments of the present invention, the intercepting is performed in a manner that it transparent to the client and to the service. In accordance with one or more embodiments, the intercepting a result, capturing a new state and persisting the new state are performed without notifying the service or the intended recipient and without modifying computer code of the service or the intended recipient.

In accordance with one or more embodiments of the present invention, the transaction object can be used to cancel the in-flight synchronous transaction. In accordance with one or more embodiments of the present invention, the transaction object is used to replay the synchronous transaction from a first domain to a second domain. In accordance with one or more embodiments of the present invention, the current state of the in-flight synchronous transaction is viewable via a user interface. In accordance with one or more embodiments of the present invention the transaction object is viewable via a user interface when the synchronous transaction is in-flight and after the synchronous transaction completes. In accordance with one or more embodiments of the present invention, the transaction object is utilized to rollback a sub-transaction of the synchronous transaction.

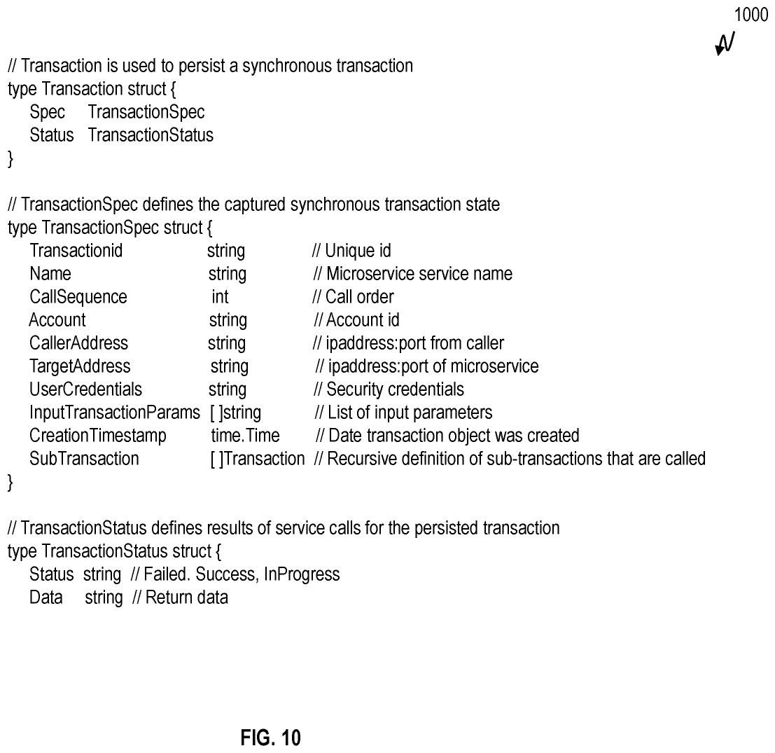

Turning now to FIG. 10, an example definition 1000 of a STF persisted transaction object is generally shown in accordance with one or more embodiments of the present invention.

By persisting intermediate transaction states as objects with request/reply transaction data and sub-transactions as described herein, the persisted data can be used to perform actions a typical synchronous transaction system cannot perform (e.g. provide history, status, rollback, cancel, system outage recovery, etc.). Embodiments of the present invention can be applied to existing systems with no changes to code by using the STF proxy described herein. Embodiments of the present invention can be implemented as a proxy or as a standard library call interface.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
intercepting a call to invoke execution of a service as part of performing a synchronous transaction;
capturing a current state of the synchronous transaction;
persisting the current state in a transaction object corresponding to the synchronous transaction; and
invoking execution of the service.

2. The computer-implemented method of claim 1, wherein the call is from a client, and the intercepting, capturing, and persisting are performed without notifying the client and without modifying computer code of the client.

3. The computer-implemented method of claim 1, wherein the call is from another service.

4. The computer-implemented method of claim 1, further comprising:
intercepting a result of the call from the service, the result having an intended recipient;
capturing a new state of the synchronous transaction, the new state based at least in part on the result;
persisting the new state as the current state in the transaction object; and
sending the result to the intended recipient.

5. The computer-implemented method of claim 4, wherein the intercepting a result, capturing a new state and persisting the new state are performed without notifying the service and without modifying computer code of the service.

6. The computer-implemented method of claim 1, further comprising utilizing the transaction object to cancel the synchronous transaction before it completes.

7. The computer-implemented method of claim 1, further comprising utilizing the transaction object to replay the synchronous transaction from a first domain to a second domain.

8. The computer-implemented method of claim 1, wherein the current state of the synchronous transaction is viewable via a user interface.

9. The computer-implemented method of claim 1, wherein the transaction object is viewable via a user interface when the synchronous transaction is in-flight and after the synchronous transaction completes.

10. The computer-implemented method of claim 1, further comprising utilizing the transaction object to rollback a sub-transaction of the synchronous transaction.

11. A system comprising:
a memory having computer readable instructions; and
one or more processors for executing the computer readable instructions, the computer readable instructions controlling the one or more processors to perform operations comprising:
intercepting a call to invoke execution of a service as part of performing a synchronous transaction;
capturing a current state of the synchronous transaction;
persisting the current state in a transaction object corresponding to the synchronous transaction; and
invoking execution of the service.

12. The system of claim 11, wherein the call is from a client, and the intercepting, capturing, and persisting are performed without notifying the client and without modifying computer code of the client.

13. The system of claim 11, wherein the call is from another service.

14. The system of claim 11, wherein the operations further comprise:
intercepting a result of the call from the service, the result having an intended recipient;
capturing a new state of the synchronous transaction, the new state based at least in part on the result;
persisting the new state as the current state in the transaction object; and
sending the result to the intended recipient.

15. The system of claim 14, wherein the intercepting a result, capturing a new state and persisting the new state are performed without notifying the service and without modifying computer code of the service.

16. The system of claim 11, wherein the operations further comprise utilizing the transaction object to cancel the synchronous transaction before it is completed.

17. The system of claim 11, wherein the operations further comprise utilizing the transaction object to replay the synchronous transaction from a first domain to a second domain.

18. The system of claim 11, wherein the current state of the synchronous transaction is viewable via a user interface.

19. A computer program product comprising a computer readable storage medium having program instructions embodied therewith, the program instructions executable by a processor to cause the processor to perform operations comprising:
intercepting a call to invoke execution of a service as part of performing a synchronous transaction;
capturing a current state of the synchronous transaction;
persisting the current state in a transaction object corresponding to the synchronous transaction; and
invoking execution of the service.

20. The computer program product of claim 19, wherein the call is from a client, and the intercepting, capturing, and persisting are performed without notifying the client and without modifying computer code of the client.
